(19) United States
(12) Patent Application Publication
(10) Pub. No.: US 2026/0021964 A1
(43) Pub. Date: Jan. 22, 2026

(54) RESERVOIR AND METHOD FOR OPERATING THE RESERVOIR

(71) Applicant: G.D S.P.A., Bologna (BO) (IT)

(72) Inventors: Valerio AMORATI, Bologna (BO) (IT); Manuele CUCCHI, Bologna (BO) (IT); Giampaolo GIANESE; Mirco LEGNANI; Luca TESTONI

(21) Appl. No.: 18/998,019

(22) PCT Filed: Jul. 18, 2023
(86) PCT No.: PCT/IB2023/057302

§ 371 Date: Jan. 23, 2025

(30) Foreign Application Priority Data
Jul. 25, 2022 (IT) 102022000015567

(51) Int. Cl. B65G 1/04; B65G 61/00

(52) U.S. Cl. CPC B65G 1/0485; B65G 1/045; B65G 61/00; B65G 2203/0233; B65G 2811/095

(57) ABSTRACT

A reservoir, including: a feed station equipped with a feed transfer device and associated with a feed line for feeding articles; a pickup station equipped with a pickup transfer device and associated with a removal line for removing articles; a movable support provided with a plurality of receiving seats and configured to move the receiving seats along a closed path passing through the feed station and the pickup station; detecting means for detecting a filled condition of at least some of the receiving seats; a control unit connected to the detecting means and configured to drive the transfer devices according to a logic of variable transfer frequency as a function of the filled condition received from the detecting means.

### TECHNICAL FIELD

This invention relates to a reservoir and to a method for operating the reservoir.

The invention addresses the sector of industrial processes for the production, processing and packaging of articles in general. The type of articles, therefore, is not a limiting factor in the context of this invention. Whatever the case, by “article” is meant, preferably, a single object which can be gripped, transported and released individually. By way of a non-exhaustive example, the following may be considered articles according to this invention: food or confectionery products; components or sub-units of electronic cigarettes; electronic components; small mechanical parts.

### Background art

Known in the prior art are product reservoirs, multi-level in some cases, provided with input and output transfer devices configured to transfer articles to and from respective storage areas.

In particular, tower solutions are known, where the products are stored on different levels and taken in or out by suitable transfer devices which must constantly move in three dimensions, vertically to reach the necessary level and horizontally in a plane at the level reached, in order to place the articles in respective receiving seats or to pick the articles up from the respective receiving seats.

In some cases, the transfer devices are movable to respective transfer stations and the receiving seats are stationary at the transfer stations. In such a case, the transfer devices may sometimes be unable to perform the transfer, in particular in the case where the receiving seats are completely full and the articles need to be released into them or completely empty and the articles need to be withdrawn from them. In such a situation, the transfer device is placed on stand-by, waiting for a situation where transfer can resume, and thus building up a time delay which often cannot be estimated beforehand and which is sometimes impossible to recover, leading to an excessive number of articles coming in and no articles going out. That means the reservoir operates incorrectly and is unsuitable for its purpose, which is to act as a buffer between the feed lines upstream and downstream of the reservoir itself.

### DISCLOSURE OF THE INVENTION

In this context, the basic technical purpose of this invention is to provide a reservoir and a method for operating the reservoir to overcome the above mentioned disadvantages of the prior art.

In particular, the aim of this invention is to provide a reservoir and a method for operating the reservoir which offer optimum storage efficiency.

The technical purpose indicated and the aim specified are substantially achieved by a reservoir and a method for operating the reservoir comprising the technical features set out in claims 1 and 12 and/or in one or more of the claims dependent thereon.

### BRIEF DESCRIPTION OF THE DRAWINGS

Further features and advantages of the invention are more apparent in the non-limiting description which follows of a preferred but non-exclusive embodiment of a reservoir and a method for operating the reservoir, as illustrated in the accompanying drawings, in which:

FIG. 1 is a simplified perspective view of a reservoir according to this invention;

FIG. 2 shows a schematic plan view of the reservoir of FIG. 1;

FIG. 3 shows an enlarged view of a first portion of the reservoir of FIG. 1, with the addition of a virtual visual indication;

FIG. 4 shows an enlarged view of a second portion of the reservoir of FIG. 1, with the addition of a virtual visual indication;

FIGS. 5-8 represent a sequence of operating steps of the reservoir of FIG. 1 according to an operating condition.

### DETAILED DESCRIPTION OF PREFERRED EMBODIMENTS OF THE INVENTION

The numeral 1 in the accompanying drawings denotes in its entirety a reservoir according to this invention, suitable for the temporary storage of articles.

In the context of this invention, the term “articles” is used to denote products of diverse kinds such as, by way of non-limiting example: food or confectionery products; components or sub-units of electronic cigarettes; electronic components; small mechanical parts.

Regardless of the type of product, the reservoir 1 is suitable for working between a production line upstream and a processing or packaging line downstream, to hold or deliver articles when the capacities of the lines upstream and downstream are imbalanced.

The reservoir 1 is, in particular, a “dynamic” reservoir, that is to say, suitable for the temporary storage of articles based on one or more criteria which take into account how full it is at any time, hence not necessarily linked to a sequential order of filling.

Moreover, the reservoir 1 is of a mobile type, that is to say, normally mobile in such a way as to move the articles and the respective housings cyclically, in particular with continuous and/or uniform motion (for example, intermittent with constant, stepped operation.

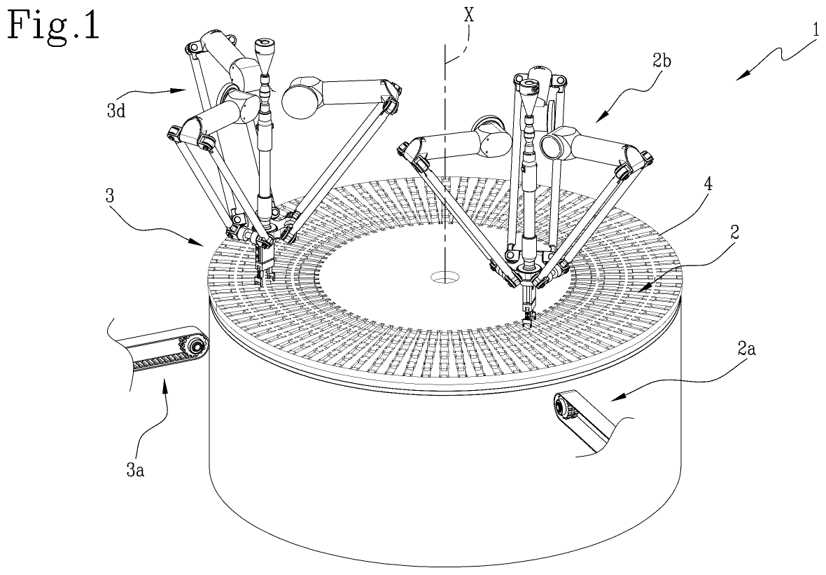

Looking in more detail, as shown in FIG. 1, the reservoir 1 comprises one or more feed stations 2, each associated or associable with at least one respective feed line 2a for feeding articles and equipped with a respective feed transfer device 2b, and one or more pickup stations 3, each associated or associable with at least one respective removal line 3 for removing articles and equipped with a respective pickup transfer device 3b.

The reservoir 1 also comprises a movable support 4 provided with a plurality of receiving seats 5 for receiving single articles (not illustrated) and configured to move the receiving seats 5 along a closed path passing through the feed station 2 and the pickup station 3 so that the articles are fed to the movable support 4 by the feed transfer device (or devices) 2b and the articles are removed from the movable support 4 by the pickup transfer device (or devices) 3b.

The reservoir 1 is configured to move individual articles towards and away from the movable support 4; in other words, the transfer devices 2b, 3b are configured to pick up, transfer and release one single article at a time (according to the embodiment illustrated). Alternatively, the transfer devices 2b, 3b may be configured to pick up, transfer and release a group of articles at a time.

The transfer devices 2b, 3b illustrated are in the form of articulated arms; they may, however, be embodied in any form, for example, Cartesian actuators, anthropomorphic robots and so on.

Preferably, the receiving seats 5 are distributed on the movable support 5 according to a two-dimensional distribution, in particular, in a plurality of longitudinal rows (circles) running alongside each other.

The movable support 4 is made preferably in the form of a carousel or rotary disc, in particular, rotating about a vertical axis X. The carousel or rotary disc has an integral structure, that is to say, all the receiving seats 5 are movable along the closed path simultaneously.

Preferably, the movable support 4 moves with continuous motion, in particular at a constant speed, along the closed path.

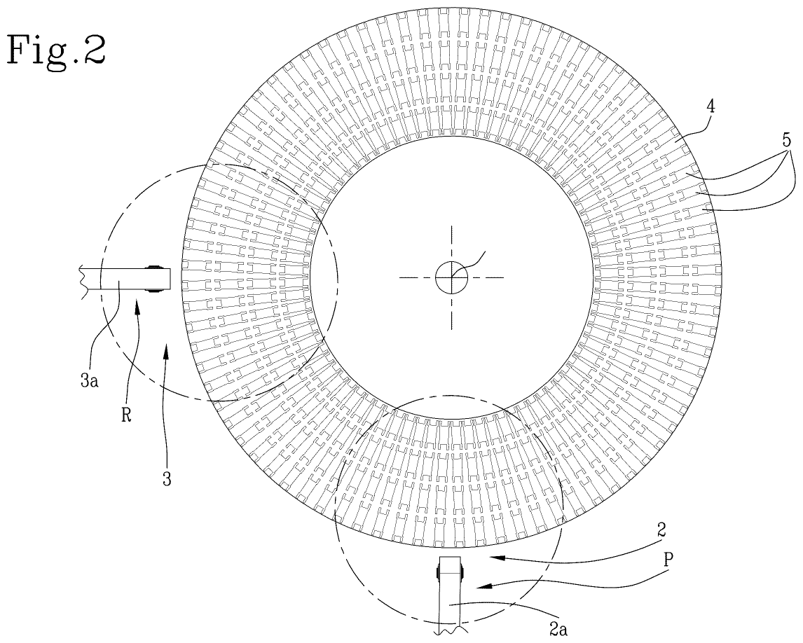

FIG. 2 shows a plan view of the reservoir 1, where the operating range of each of the two transfer devices 2b, 3b is drawn with a dashed line. Preferably, the operating range is substantially circular, although other shapes are imaginable (for example, rectangular or square in the case of Cartesian actuators).

According to the invention, the reservoir 1 also comprises detecting means (not illustrated) for detecting a filled condition of at least some of the receiving seats. In particular, the detecting means can detect a filled condition only of the receiving seats 5 that are currently within the operating ranges of the transfer devices 2b, 3b, or a filled condition of the receiving seats 5 located in portions of the movable support 4 outside the operating ranges of the transfer devices 2b, 3b, or a filled condition of all the receiving seats 5 on the movable support 4.

Preferably, the detecting means are configured to detect the filled condition at predetermined time intervals, in particular, at time intervals preferably shorter than the time that elapses between the passage of one receiving seat 5 and the next receiving seat 5. More preferably, detection occurs at a frequency greater than or equal to 5 Hz, which, in the context of this use, corresponds to continuous or “quasi-continuous” detection.

In a preferred embodiment, the detecting means comprise one or more cameras, for example, located above the movable support 4.

In an alternative solution, the detecting means are presence sensors inside each receiving seat 5 and configured to generate an article present and/or absent signal at the aforesaid predetermined frequency or to detect an absent/present variation condition and vice versa.

The detecting means thus generate respective (optical and/or electrical) signals identifying the filled condition of at least some of the receiving seats 5 of the movable support 4.

The reservoir 1 also comprises a control unit (not illustrated) connected to the transfer devices 2b, 3b and configured to drive the transfer device 2b, 3b as a function of the current capacity values of the feed and removal lines 2a, 3a. In particular, the control unit is configured to drive each transfer device 2b, 3b independently and at a variable transfer frequency or speed, in particular as a function of the signal received from the detecting means regarding the filled condition of the receiving seats 5.

The variable transfer frequency is included between a minimum transfer frequency (in particular, zero, when the transfer device is stopped) and a maximum transfer frequency.

Preferably, the feed line 2a and/or the removal line 3a have an article transporting frequency included between the aforesaid minimum and maximum transfer frequencies and preferably constant.

That way, the transfer devices 2b, 3b can each operate, at least temporarily, at a transfer frequency greater than the article transporting frequency of the respective feed or removal line 2a, 3a. Consequently, in the event of an unwanted buildup of transfer operations (for example, due to full receiving seats 5 in the case of the feed transfer device 2b or empty seats in the case of the pickup transfer device 3b), the transfer device 2b, 3b (which normally operates at a transfer frequency lower than the maximum frequency) can work off the backlog and return to a less critical situation.

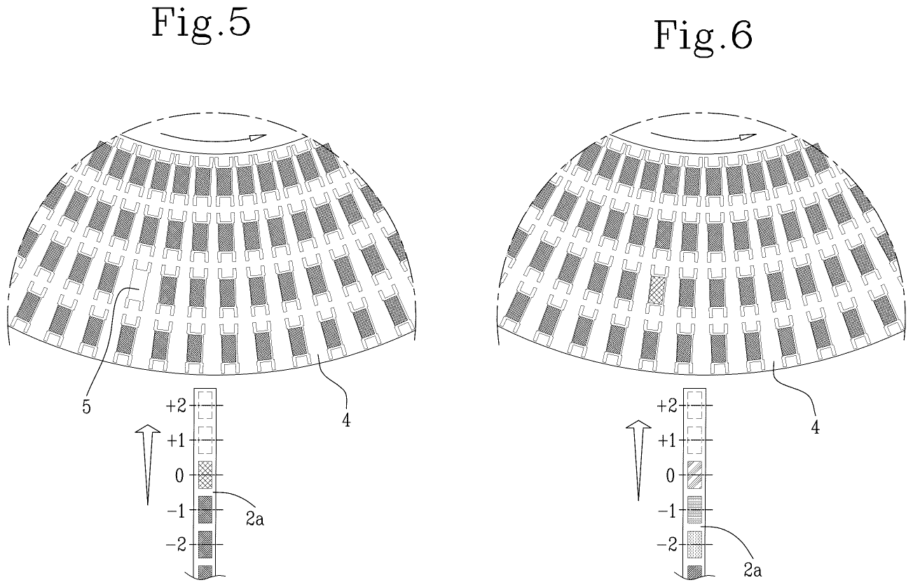

Preferably, the feed and/or removal lines 2a, 3a are configured to transport the individual articles in orderly succession along a feed direction, as shown in FIGS. 5 to 8.

Furthermore, at least one of the transfer devices 2b, 3b, preferably both of them, has a respective operating range defining a pickup zone P on the respective feed line 2a and/or a release zone R on the respective removal line 3a where the operating range is defined by a closed line, which is, for example, circular (in the case of a robotized arm) or square/rectangular (in the case of a Cartesian transfer device).

According to the invention, the pickup zone P comprises three or more positions disposed in sequence on the respective feed line 2a and corresponding, respectively, to three or more corresponding articles disposed in sequence on the respective feed line 2a, and/or the release zone R comprises three or more positions disposed in sequence on the respective removal line 3a and corresponding, respectively, to three or more free slots disposed on the respective removal line 3a (the slots may be defined by specific receiving portions, for example, housings, or by surface portions allocated virtually for receiving an article).

Preferably, the pickup zone P and the release zone R each comprise a number of positions included between three and seven, and more preferably, equal to five.

More generally speaking, the aforesaid positions comprise a nominal, pickup or release position and at least one back position and one forward position, where one of the back positions and forward positions defines an advanced pickup or release position relative to the nominal position and the other of the back positions and forward positions defines a delayed pickup or release position, where the nominal position is included between one advanced pickup/release position and at least one delayed pickup/release position.

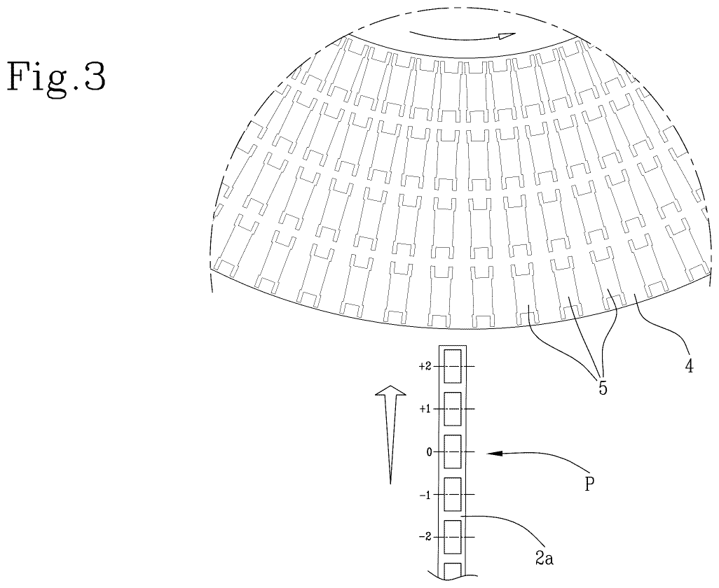

FIG. 3 shows an example embodiment of such a solution in the pickup zone P, where the nominal position is labelled 0, while +1 and +2 indicate the delayed pickup zones (articles disposed downstream of the nominal position, hence needing to be picked up more urgently), and −1 and −2 indicate the advanced pickup zones (articles disposed upstream of the nominal position, hence needing to be picked up less urgently). Preferably, therefore, the aforesaid positions are represented by algebraic numbers, where 0 is the nominal position while the positive and negative numbers are the delayed and advanced positions respectively.

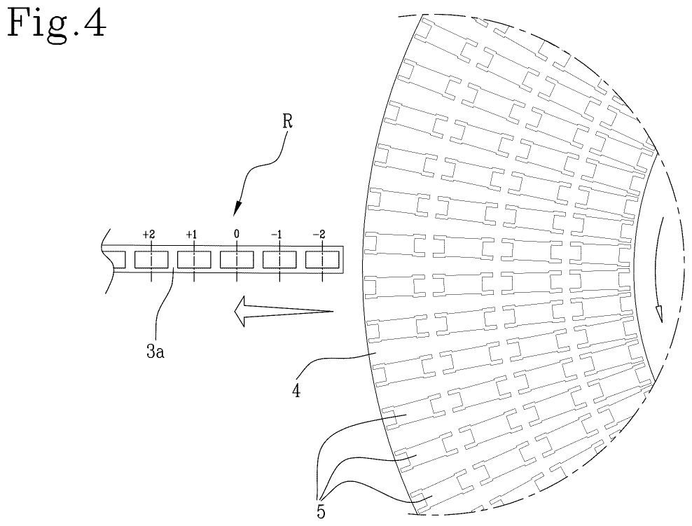

FIG. 4 shows the application of the same solution to the release zone R where the delayed positions (+1, +2) are, in this case too, disposed downstream of the nominal position and indicate positions getting further away from the pickup transfer device 3b, hence needing to be transferred urgently.

Preferably, the control unit is also configured to determine and store, for the aforesaid transfer devices 2b, 3b, an information item relating to the current position adopted by the first article disposed furthest downstream in the respective pickup zone P or relating to the current position adopted by the first free slot disposed in the release zone R. Preferably, this information item is defined by an algebraic counter (positive or negative integer) determined as a function of the current position.

FIGS. 5 to 8 represent a sequence of operating steps according to this solution and directed towards the feed station 2.

In FIG. 5, the first article in the pickup zone P (that is, the article furthest downstream) is disposed at the nominal position, identified as the 0 position. In this situation, the detecting means detect the presence of an available receiving seat 5 on the movable support 4 and provide the control unit with a corresponding signal. On receiving this signal, the control unit activates the feed transfer device 2b to pick up the article and to place it in that receiving seat 5.

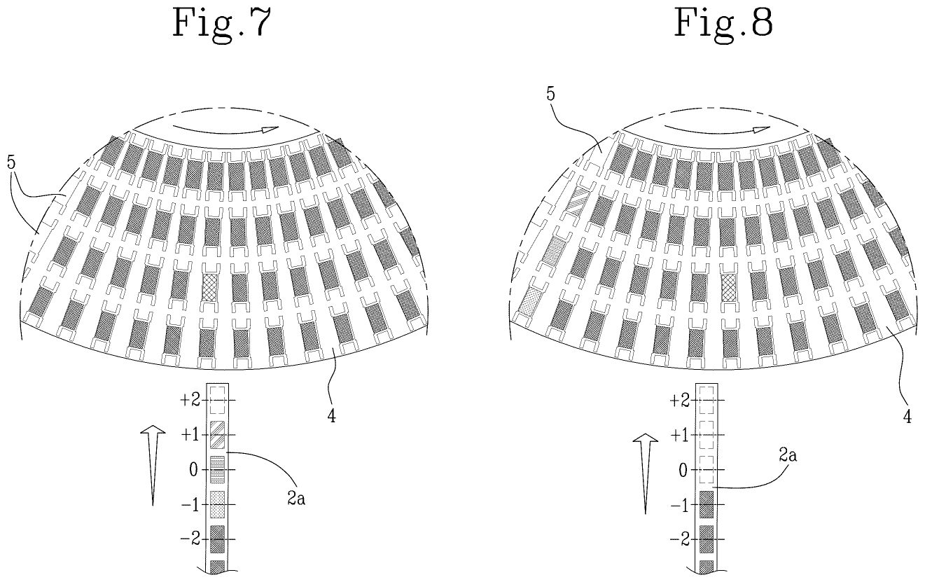

Next, the feed line 2a advances the articles (with preferably intermittent motion or, alternatively, continuous motion) until another article is disposed at the nominal position 0 and the movable support 4 can advance (with preferably intermittent motion or, alternatively, continuous motion) by one step, corresponding to the distance between the next two receiving seats 5 (FIG. 6). In this situation, however, the detecting means do not detect any available receiving seat 5, hence the control unit does not activate the feed transfer device 2b. At the same time, the feed line 2a advances the articles until the preceding article is disposed at the advanced position +1 and the movable support 4 can advance by another step corresponding to the distance between the next two receiving seats 5 (FIG. 7).

In this case too, the detecting means do not detect any available receiving seat 5, hence the control unit does not activate the feed transfer device 2b. At the same time, the feed line 2a advances the articles until the preceding article is disposed at the advanced position +2 and the movable support 4 can advance by another step corresponding to the distance between the next two receiving seats 5.

Since some receiving seats 5, in particular, three receiving seats, are now available, the detecting means detect the presence of these available receiving seats 5 and provide the control unit with a corresponding signal. On receiving this signal and to the knowledge of the current counter at the +2 position, the control unit activates the feed transfer device 2b to pick three articles and to place them in those receiving seats 5 (FIG. 8). This transfer operation occurs at a frequency greater than the “normal” frequency″, that is to say, greater than the frequency of the articles on the feed line 2a and of the receiving seats 5 on the movable support 4, so as to compensate for the delay and at least partly recover it.

Following the triple transfer, the numeric counter can thus adopt the value −1 and, in the next step (not illustrated) is once again set to 0 for another transfer operation.

According to this operation, it is noted that under “nominal” conditions, that is to say, without delays (there being receiving seats available for articles to be placed in or picked up from), the transfer frequency at which the transfer device 2b, 3b operates can be determined only by the advancing speed of the articles on the respective feed and removal lines 2a, 3a. The transfer frequency is thus varied when delays start building up, in particular when articles accumulate on the feed line 2a (or when the articles on the removal line 3a are too few), hence when the numeric counter adopts a value of +1 or following. In such a case, the transfer device 2b, 3b involved is operated temporarily at a higher transfer frequency until the counter returns to a value of 0 or less. In effect, the control unit can advantageously be configured to set the counter, where possible, to negative values, thus working “in advance” and compensating in advance for any delays that might accidentally arise, in particular, in the event of imbalances between the current capacities of the feed line 2a and removal line 3a. Indeed, in the event of such an imbalance, the distribution of the articles on the movable support 4 may become more closely packed or thinned out to the point of preventing the transfer devices 2b, 3b from performing one or more transfers, thus giving rise to delays. In the context of this disclosure, the expression “current capacity” means the quantity (or flow) of articles per unit time at a given instant (measured, for example, in articles/second or articles/minute).

In particular, therefore, it is preferable for the control unit to be programmed according to a control logic such as to operate the transfer devices 2b, 3b in advance in order to avoid probable delays should such an imbalance arise between the current capacities of the feed line 2a and removal line 3a. Alternatively, the control unit might be programmed according to this advanced operation logic at all times, with the aim of setting the counter to the lowest possible value (for example, −2, −3, and so on).

The same logic may also be applied to the pickup station 3 without variations.

More generally speaking, therefore, the control unit is configured for:
reducing the transfer frequency of the feed transfer device 2b or stopping the feed transfer device 2b when the detecting means detect a receiving seats 5 filled condition of the movable support 4 greater than a predetermined value or an absence of available receiving seats 5 in the operating range of the feed transfer device 2b, and/or
increasing the transfer speed of the feed transfer device 2b when the detecting means detect a pickup zone P filled condition that is greater than a predetermined value (positive counter values).

The control unit is also configured for:
reducing the transfer frequency of the release transfer device 3b or stopping the release transfer device 3b when the detecting means detect a receiving seats 5 filled condition of the movable support 4 less than a predetermined value or an absence of receiving seats 5 containing articles in the operating range of the release transfer device 3b, and/or
increasing the transfer speed of the release transfer device 3b when the detecting means detect a release zone R filled condition that is less than a predetermined value (positive counter values).

The invention achieves the preset aim, overcoming the disadvantages of the prior art.

In effect, the reservoir is optimized for managing (compensating) transfer delays caused by one or more of the transfer devices being unable to perform one or more transfer operations. Such an inability to perform is due, for example, to the absence of available receiving seats in which to place articles or the absence of available articles to be picked up from the movable support, or even due to a temporary inability of the transfer device (temporary faults or causes of temporary stoppage). In this situation, the control unit of the reservoir accelerates transfer to allow the transfer device to compensate for any delay that has already built up or to reach an advanced condition ahead of possible future delays. Such situations can be identified by an algebraic counter directly representing the first available article on the feed line or the first free slot on the removal line.

1. A reservoir, comprising:
at least one feed station equipped with a feed transfer device and associated or associable with a respective feed line for feeding articles;
at least one pickup station equipped with a pickup transfer device and associated or associable with a respective removal line for removing articles;
a movable support provided with a plurality of receiving seats for receiving single articles and configured to move the receiving seats along a closed path passing through the feed station and the pickup station so that the articles are fed to the movable support by the feed transfer device and the articles are removed from the movable support by the pickup transfer device ;
detecting means for detecting a filled condition of at least some of the receiving seats;
a control unit connected to the detecting means and configured to drive the transfer devices according to a logic of variable transfer frequency as a function of the filled condition received from the detecting means.

2. The reservoir according to claim 1, wherein the variable transfer frequency is between a minimum transfer frequency and a maximum transfer frequency, the feed line and/or the removal line transporting the articles with a frequency between the minimum transfer frequency and the maximum transfer frequency and preferably with a constant frequency.

3. The reservoir according to claim 1 or 2, wherein the feed line and/or the removal line are configured to transport the articles in orderly succession along a feed direction and wherein at least one of the transfer devices has a operating range defining a pickup zone (P) on the respective feed line or a release zone (R) on the respective removal line, wherein the pickup zone (P) comprises three or more positions disposed in sequence on the respective feed line and corresponding, respectively, to three or more corresponding articles disposed in sequence on the respective feed line and/or wherein the release zone (R) comprises three or more positions disposed in sequence on the respective removal line and corresponding, respectively, to three or more free slots disposed on the respective removal line; the three positions comprising a nominal, pickup or release position (0) and at least one back position (−1, −2) and one forward position (+1, +2), wherein one of the back positions (−1, −2) and forward positions (+1, +2) defines an advanced pickup or release position relative to the nominal position (0) and the other of the back positions (−1, −2) and forward positions (+1, +2) defines a delayed pickup or release position.

4. The reservoir according to claim 3, wherein the detecting means are also configured to detect the filled state of the pickup zone (P) and of the release zone (R) and wherein the control unit is also configured to determine and store, for the at least one transfer device, an information item relating to the current position adopted by the first article disposed furthest downstream in the respective pickup zone (P) or relating to the current position adopted by the first free slot disposed in the release zone (R), the information item being preferably defined by an algebraic counter determined as a function of the current position.

5. The reservoir according to claim 1. wherein the control unit is configured for:
reducing the transfer frequency of the at least one feed transfer device or stopping the at least one feed transfer device when the detecting means detect a receiving seats filled condition of the movable support greater than a predetermined value or an absence of available receiving seats in the operating range of the feed transfer device, and/or
increasing the transfer speed of the at least one feed transfer device when the detecting means detect a pickup zone (P) filled condition that is greater than a predetermined value.

6. The reservoir according to claim 1, wherein the control unit is configured for:
reducing the transfer frequency of the at least one pickup transfer device or stopping the at least one pickup transfer device when the detecting means detect a receiving seats filled condition of the movable support less than a predetermined value or an absence of receiving seats containing articles in the operating range of the pickup transfer device, and/or
increasing the transfer speed of the at least one pickup transfer device when the detecting means detect a release zone (R) filled condition that is less than a predetermined value.

7. The reservoir according to claim 1, wherein the detecting means are configured for detecting, in particular continuously, a filled condition of portions of the movable support that are disposed at the feed station and pickup station, these portions being defined by the operating range of the respective transfer devices.

8. The reservoir according to claim 1, wherein the receiving seats are distributed on the movable support according to a two-dimensional distribution, in particular, in a plurality of longitudinal rows running alongside each other.

9. The reservoir according to claim 1, wherein the movable support is made in the form of a carousel or rotary disc, in particular, rotating about a vertical axis.

10. The reservoir according to claim 1, wherein all the receiving seats are movable along the closed path simultaneously.

11. The reservoir according to claim 1, wherein the feed and/or pickup transfer devices are configured for individually transferring single articles and are preferably embodied in the form of motor-driven or robotized arms.

12. A method for operating a reservoir, in particular, a reservoir according to any one of the preceding claims, claim 1, wherein the reservoir comprises at least one feed station equipped with a feed transfer device and associated with a respective feed line for feeding articles, at least one pickup station equipped with a pickup transfer device and associated with a respective removal line for removing articles, and a movable support provided with a plurality of receiving seats for receiving single articles, the method comprising the following steps:
moving the movable support in such a way as to move the receiving seats along a closed path passing through the feed station and the pickup station so that the articles are fed to the movable support by the feed transfer device and the articles are removed from the movable support by the pickup transfer device;
detecting a filled condition of at least some of the receiving seats;
driving the transfer devices according to a logic of variable transfer frequency as a function of the filled condition received detected.

13. The method according to claim 12, wherein the variable transfer frequency is between a minimum transfer frequency and a maximum transfer frequency, the feed line and/or the removal line being operated so they transport the articles with a frequency between the minimum transfer frequency and the maximum transfer frequency and preferably with a constant frequency.

14. The method according to claim 12, wherein the articles are disposed and transported in orderly succession on the feed line and/or the removal line along a feed direction and wherein at least one of the transfer devices has an operating range defining a pickup zone (P) on the respective feed line and/or a release zone (R) on the respective removal line, wherein the pickup zone (P) comprises three or more positions disposed in sequence on the respective feed line and corresponding, respectively, to three or more corresponding articles disposed in sequence on the respective feed line and/or wherein the release zone (R) comprises three or more positions disposed in sequence on the respective removal line and corresponding, respectively, to three or more free slots disposed on the respective removal line; the three positions comprising a nominal, pickup or removal position (0) and at least one back position (−1, −2) and one forward position (+1, +2), wherein one of the back positions (−1, −2) and forward positions (+1, +2) defines an advanced pickup or release position relative to the nominal position (0) and the other of the back positions (−1, −2) and forward positions (+1, +2) defines a delayed pickup or release position.

15. The method according to claim 14, wherein the step of detecting is also carried out to detect the filled state of the pickup zone (P) and of the release zone (R) and wherein the method further comprises a step of determining and storing, for the at least one transfer device, an information item relating to the current position adopted by the first article disposed furthest downstream in the respective pickup zone (P) or relating to the current position adopted by the first free slot disposed in the release zone (R), the information item being preferably defined by an algebraic counter determined as a function of the current position.

16. The method according to claim 12, comprising a step of reducing the transfer frequency of the at least one feed transfer device or stopping the at least one feed transfer device when the detected receiving seats filled condition of the movable support is greater than a predetermined value or indicates an absence of available receiving seats in the operating range of the feed transfer device, and/or a step of increasing the transfer speed of the at least one feed transfer device when the detected pickup zone (P) filled condition is greater than a predetermined value.

17. The method according to claim 12, further comprising a step of reducing the transfer frequency of the at least one feed transfer device or stopping the at least one feed transfer device when the detected receiving seats filled condition of the movable support is less than a predetermined value or indicates an absence, in the operating range of the feed transfer device, of receiving seats containing articles, and/or a step of increasing the transfer speed of the at least one feed transfer device when the detected release zone (R) filled condition is less than a predetermined value.
